(19) United States
(12) Patent Application Publication
(10) Pub. No.: US 2014/0153503 A1
(43) Pub. Date: Jun. 5, 2014

(54) SYSTEMS AND METHODS FOR BEACONING AND MANAGEMENT IN BANDWIDTH ADAPTIVE WIRELESS NETWORKS

(71) Applicants: Vikram Srinivasan, Bangalore (IN); Supratim Deb, Murray Hill, NJ (US); Kanthi C N, Bangalore (IN); Piyush Gupta, Murray Hill, NJ (US)

(72) Inventors: Vikram Srinivasan, Bangalore (IN); Supratim Deb, Murray Hill, NJ (US); Kanthi C N, Bangalore (IN); Piyush Gupta, Murray Hill, NJ (US)

(73) Assignee: ALCATEL LUCENT, Paris (FR)

(21) Appl. No.: 14/008,706

(22) PCT Filed: Mar. 23, 2012
(86) PCT No.: PCT/EP2012/055185

§ 371 Date: Feb. 18, 2014

(30) Foreign Application Priority Data
Mar. 30, 2011 (IN) 1006/CHE/2011

(51) Int. Cl. H04W 28/20

(52) U.S. Cl. CPC H04W 28/20
USPC 370/329

(57) ABSTRACT

Systems and methods for beaconing and management in bandwidth adaptive wireless networks are disclosed. The present invention relates to bandwidth allocation for access points and, more particularly, to bandwidth allocation for access points in wireless networks. The method employs mechanisms for beaconing and management to associate clients with Access Point (AP). The beaconing mechanism allows the client to discover part of the spectrum over which an AP operates efficiently. Periodic beacon messages are sent by AP to the client over the bandwidth of operation of the channel. The client then sends a client association request and gets associated with the AP. Further, critical information is conveyed to the AP in the beacon message. The AP further allocates the client to one of its radios of operation. The system is configured to handle disruptions and switching the AP to different parts of the spectrum during such disruptions.

### TECHNICAL FIELD

The present invention relates to bandwidth allocation for access points and, more particularly, to bandwidth allocation for access points in wireless networks.

### BACKGROUND

With the developments in technology demand for bandwidth employed for communication is increasing. However, bandwidth available for transmission of information in a communication network is constrained by limits of the equipments used to transmit and receive information carrier signals, and physical properties of the media over which the carrier signals are transmitted. Some of the present day networks are employing mechanisms to regulate usage of network bandwidth by pre-allocating predefined bandwidths to respective applications. For example, the available communication networks pre-allocate fixed bandwidths to respective network applications whose requirements for bandwidth of operation may or may not be known. In this case, as the bandwidths are pre-allocated, and the bandwidth assigned for one application cannot be used for another application even when the application is not using a portion or all of the allocated bandwidth there is no effective usage of the available bandwidth. Consequently, in such networks the total bandwidth that the applications of the network require or use often exceeds the bandwidth available with the access point.

Further, technologies today are employing dynamic spectrum and bandwidth allocation mechanisms. Allocation refers to the spectrum or bandwidth allocation to wireless access points, wireless mesh nodes, or even base stations. It is known that the spectrum used by the access point varies with time. As a result, the spectrum may be allocated to the clients on dynamic basis as and when the demand arises for the client. Parts of the spectrum referred to as whitespace spectrum is available for unlicensed access for various applications. Attempts have been made in order to exploit this available spectrum efficiently.

However, present day networks do not have effective mechanisms to decide which parts of the spectrum is experiencing less interference and move the access point's to that particular part of the spectrum or if a particular access point is not using the spectrum then release the spectrum so that it is available for another access point for use.

In addition, present day networks face some drawbacks. For example, present day networks do not have means for a client to identify the center frequencies over which an access point is operating and determining the bandwidths over which the access point is in operation so as to ensure efficient utilization of the whitespace spectrum. Further, the access point cannot fetch critical information from the client such as the interference it experiences from various frequency bands, data rate requirements and so on. As a result, the access point cannot allocate the client to appropriate bands over which it operates.

Some solutions for communicating with clients on the TV whitespaces consider a single radio for the access point. Further, in this case a method called as SIFT is employed to determine the center frequencies bandwidth of operation of the access points. However, these mechanisms are more complex due to single radio of the access point. Also, the Signal Inspection before Fourier Transform (SIFT) mechanism employed is not robust in a multiple access point setting and there is every possibility that the clients could draw incorrect inferences about the center frequency and amount of bandwidth over which an access point is operating. Further, the chirping mechanisms employed in these networks for detecting disruptions are not effective. This is because the backup channel employed for chirping mechanism may not be available after sometime and second the client may not detect such chirps.

Further, these networks cannot handle system disruptions for example, in the DTV whitespace spectrum if a wireless microphone or TV channel becomes active in a band that the system is operating in, the access point should switch to a different unutilized spectrum and inform its clients also to switch to this part of the spectrum. But present day networks are not effective in detecting such disruptions and indicating the access point to switch. Also, the access points are not sensitive enough in order to indicate its client to switch to a new part on the spectrum.

Due to the aforementioned drawbacks present day mechanisms for bandwidth allocation in whitespace spectrum are not effective and hence efficient allocation of the bands to the clients associated with the access point is not guaranteed.

### SUMMARY

In view of the foregoing, an embodiment herein provides an access point for dynamic allocation of bandwidths in television whitespace spectrum for plurality of clients. The access point is configured for performing a scan at intervals to determine available channels in the television whitespace spectrum, periodically sending messages over at least one of the available channel of the television whitespace spectrum, accepting a request message from a client from the plurality of clients and allocating at least one of the radios of the access point to the client for communication over the television whitespace spectrum. The access point sends the periodic messages where the message is a beacon message indicating center frequencies of operation, operating bandwidth at each of the center frequencies, signal strengths. The access point further sends the message to the client on event basis. The access point sends the messages periodically, where the period is pre-defined by the network operator and depends on factors that include at least one of channel switching overhead, duration of beacon message and tolerable overhead. The access point accepts the request where the request is a request for association of the client in order to service the client. The access point further allocates time slices at intervals over bandwidth of the spectrum o control channel.

Embodiments further disclose an access point for handling disruptions in dynamic allocation of bandwidths in television whitespace spectrum. The access point is configured for detecting if the bandwidth of the television whitespace spectrum on which the access point is operating is available, performing whitespace selection and client assignment if the bandwidth on the television whitespace spectrum s not available and sending a message over a management frame to a client associated with the access point. The access point sends the message where the message gives information on changes in allocation of the bandwidth for the client.

Embodiments herein also disclose a method for dynamic allocation of bandwidths in television whitespace spectrum for plurality of clients. The method comprising performing a scan at intervals to determine available channels in the television whitespace spectrum, periodically sending messages over at least one the available channel of the television whitespace spectrum, accepting a request message from a client from the plurality of clients and allocating at least one of the radios of the access point to the client for communication over the television whitespace spectrum. The method sends the periodic messages where the message is a beacon message indicating center frequencies of operation, operating bandwidth at each of the center frequencies, signal strengths. The method further sends the message to the client on event basis. The method sends the messages periodically, where the period is pre-defined by the network operator and depends on factors that include at least one of channel switching overhead, duration of beacon message and tolerable overhead. The method accepts the request where the request is a request for association of the client in order to service the client. The method further allocates time slices at intervals over bandwidth of the spectrum for control channel.

Also, disclosed herein is a method for handling disruptions in allocation of bandwidths in television whitespace spectrum. The method configured for detecting if the bandwidth on the television whitespace spectrum on which an access point is operating is available, performing whitespace selection and client assignment if the bandwidth on the television whitespace spectrum is not available and sending a message over a management frame to a client associated with the access point. The method sends the message where the message gives information on changes in allocation of the bandwidth for the client.

Also, disclosed herein is a method for handling disruptions in allocation of bandwidths in television whitespace spectrum. The method configured for checking by a client if a bandwidth on which the access point is operating on the television whitespace spectrum is unavailable, checking if the access point is still available for service in the television whitespace spectrum, if the access point is available for service in the television whitespace spectrum switching the client to a new bandwidth on which the access point is operating. The method switches the client to the new bandwidth by performing reallocation of bandwidth for the client.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates the architecture of the network employing access point, according to an embodiment as disclosed herein;

FIG. 2 is a flow diagram depicting the process of beaconing and client association, according to an embodiment as disclosed herein;

FIG. 3 is a flow diagram depicting the association between the client and access point, according to an embodiment as disclosed herein;

FIG. 4 is a flow diagram depicting the process of the client associating with the access point, according to an embodiment as disclosed herein; and

FIG. 5 is a flow diagram depicting the process of transmitting management time frames for the access point, according to an embodiment as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

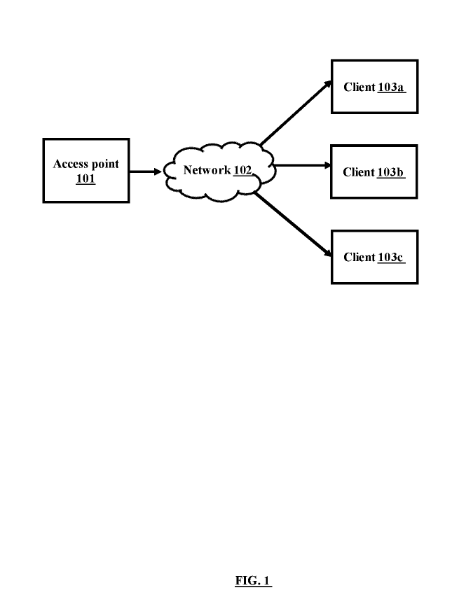

The embodiments herein disclose a mechanism for allocation of TV whitespace spectrum to access point by providing systems and methods therefore. Referring now to the drawings, and more particularly to FIGS. 1 through 5, where similar reference characters denote corresponding features consistently throughout the figures, there are shown embodiments.

Systems and methods for allocation of TV whitespace spectrum to access points in a communication network are disclosed. The method employs mechanisms for beaconing and management in order to associate the clients with an Access Point (AP). The beaconing mechanism employed allows the client to discover the part of the spectrum over which an AP operates efficiently. Periodic beacon messages are sent by the AP to the client over the bandwidth of operation of the channel. From the beacon message the client determines the frequencies most suitable for its operation. The client then sends a client association request and gets associated with the AP. In an embodiment, critical information is conveyed to the AP in the beacon message. The AP further allocates the client to one of its radios of operation. Further, subsequent communications between the client and the AP occur over this spectrum. In addition, multiple clients could also share the same spectrum to communicate with the AP.

In an embodiment, the AP is also capable of acquiring information from the clients such as interference it experiences over different frequency bands, data rate requirements and so on. Using this information the AP can allocate appropriate frequencies to the client. In addition, the system is also configured to handle disruptions and switching the AP to different parts of the spectrum during such disruptions.

FIG. 1 illustrates the architecture of the network employing access point, according to an embodiment as disclosed herein. The communication network comprises of an access point (AP) 101, the network 102 and plurality of clients 103a, 103b and 103c. The access point 101 may be a wireless access point, base station and the like. The AP 101 is a wireless AP that services clients who are in its vicinity of operation. The AP 101 connects to clients 103a, 103b, and 103c through the network 102. In an embodiment, the network may be a wireless network, wired network, Local Area Network (LAN) and so on. The AP 101 comprises of radios that enable detection of the clients and establishes connection with the clients through the network 102.

The AP 101 sends beacon message to the clients 103. The beacon message gives an indication of center frequencies, signal strengths and bandwidths over which the AP 101 operates. The message is sent to the clients 103 over the network 102. When the client 103 enters into the vicinity of the AP 101 the client 103 performs a scan to determine if there are beacon messages. When the client 103 detects the beacon message the client determines the center frequencies over which the AP 101 is in operation. If the range of frequencies is suitable for operation the client sends an association request message to the AP 101. The client gets associated with the AP 101.

In an embodiment, clients 103a, 103b and 103c may have requirements for different ranges of frequencies and depending on if the AP 101 is capable of operating in the required frequency the clients gets associated with the AP 101. Further, all the communication between the client 103 and AP 101 happens through this channel.

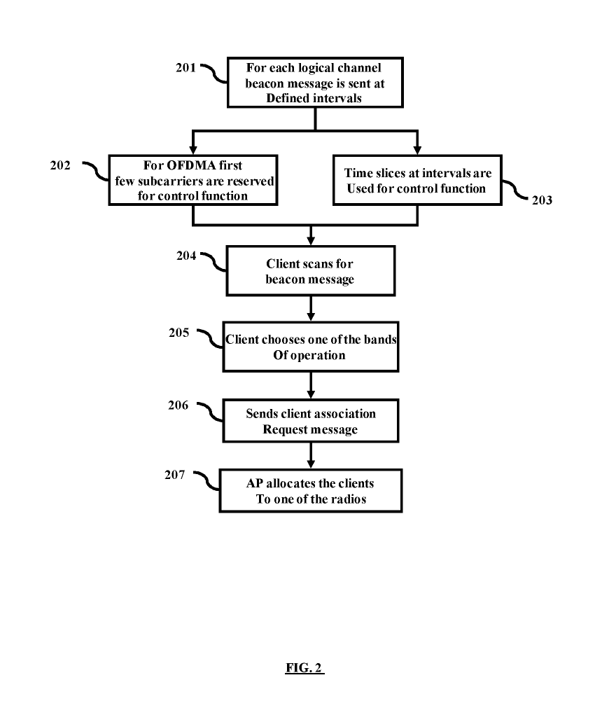

FIG. 2 is a flow diagram depicting the process of beaconing and client association, according to an embodiment as disclosed herein. At first, it is necessary to ensure that a new client who approaches the AP 101 knows about the existence of the AP 101 and can make an informed decision as to get associated with the AP 101. For this purpose, periodic beacon messages are sent over the operating channel of the AP 101. However, in case of TV whitespaces one needs to account for the fact that the AP 101 can operate over different spectrum over diverse widths at different times. Further, over each logical channel a beacon message is sent (201) over T units of time. T is referred to as beacon interval. The beacon message may contain information about center frequencies and operating bandwidths at each center frequency. In an embodiment, the T units may be pre-defined or it may be event based. In another embodiment, the value of T may be decided based on several factors that include channel switching overhead, duration of beacon message and tolerable overhead O. Based on these inputs the beacon interval T is chosen so that overhead imposed is less than tolerable overhead O.

The control channels may be chosen by two means. One is in case of Orthogonal Frequency Division Multiple Access (OFDMA) technology systems. In this case, consider the minimum bandwidth over which the AP can communicate is B. Further, assume that particular radio of an AP operates over the band of width W. Hence, the deduced logical channels are W/B. For each of these logical channels, the first few (a predefined number) sub-carriers can be reserved (202) for control purpose. For example, if B=6 MHz and there are 1024 ODMA sub-carriers over a 6 MHz spectrum, the first 24 sub-carriers can be reserved for control mechanism. Assuming that the control sub-carriers use Binary Phase Shift Keying (BPSK) modulation, this translates to 24 bits every OFDMA symbol transmission time which is around 0.16 s for 6 MHz.

In case where the OFDMA based technology is not employed it could be difficult to control the PHY transmissions at the granularity of sub-carriers. In such cases, dedicating time-slices at periodic intervals over every B width of spectrum that an AP operates over can be used (203) as control channel for performing control function.

When a client arrives in the vicinity of the AP 101 the client sequentially scans (204) every B width spectrum until it hears a beacon message. On obtaining the beacon message, the client determines the center frequencies of operation of the AP 101. If the frequency is suitable for operation the client chooses (205) one of the bands and sends a request. The client sends (206) association request with the AP 101. The client then is assigned (207) to the requested operating band. The various actions in method 200 may be performed in the order presented, in a different order or simultaneously. Further, in some embodiments, some actions listed in FIG. 2 may be omitted.

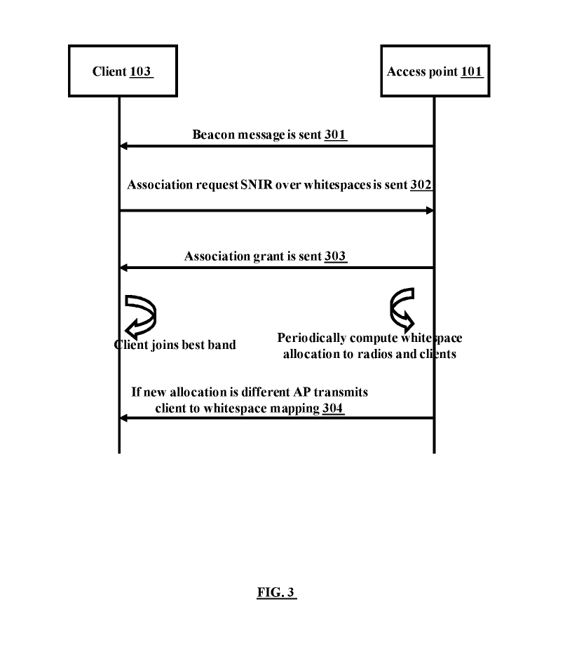

FIG. 3 is a flow diagram depicting the association between the client and access point, according to an embodiment as disclosed herein. Periodic beacon messages are sent (301) over every radio by the AP 101. When a client approaches the vicinity of the AP 101, the client detects the beacon message. For example, if a radio is operating over NumWS TV channels. Then, once every T ms (typically T=100 ms) the AP sends a beacon message over one of the NumWS TV channels. The NumWS TV channels can be used in a round robin manner. This beacon message contains information on the center frequency and bandwidth of the operating spectrum of the radio. The choice of beaconing interval can be chosen based on the channel switching overhead, duration of the beacon message, and tolerable overhead. For example, channel switching (from the current center frequency for data transmission to the center frequency of the chosen beaconing TV channel) is 3 ms as is typical of Wi-Fi systems, tolerable overhead is 5%, the duration of beacon message is under 1 ms, then the periodicity T=140 ms. The duration of beacon message is computed assuming (a) beacon messages are transmitted at lowest modulation, say BPSK with FEC 1/2, and (b) beacon message will contain center frequency (suitably indexed) and bandwidth (in how many TV channel it spans) of each of at most 3-4 radios. It is evident that no more than 1 byte/radio are required.

If the client wants to get associated with the AP 101 the client sends (302) an association request to the AP 101. The request may be Signal to Noise plus Interference Ratio (SNIR) request or the like that is sent over the TV whitespace. Further, the AP 101 sends (303) the association grants to the client. Meanwhile, the client joins the best band suitable for its operation. The AP 101 also periodically keeps a check if whitespace allocation to radios and clients is required to be updated and if required it updates the same. The AP 101 then checks (304) if new client allocation is different. If the allocation is different then the AP 101 transmits the client for whitespace allocation. The various actions in method 300 may be performed in the order presented, in a different order or simultaneously. Further, in some embodiments, some actions listed in FIG. 3 may be omitted.

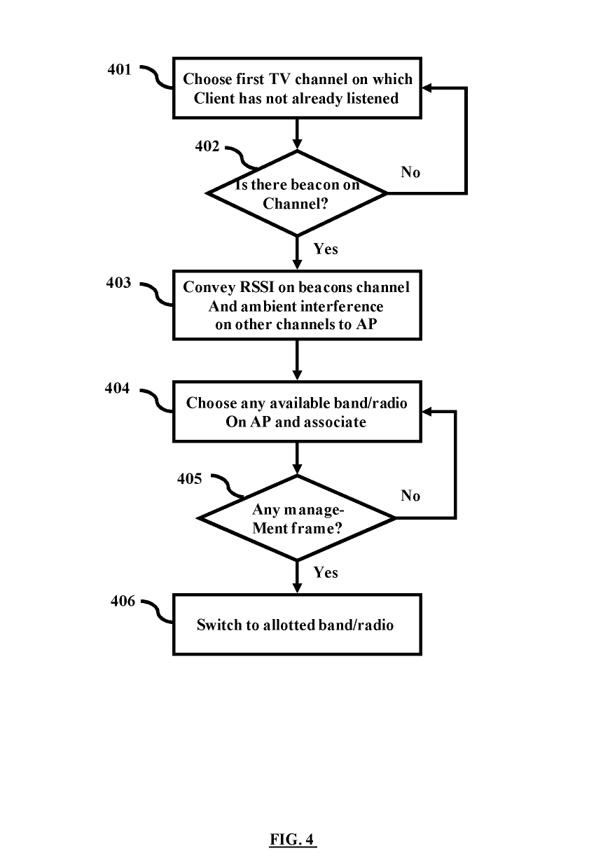

FIG. 4 is a flow diagram depicting the process of the client associating with the access point, according to an embodiment as disclosed herein. A TV channel on which the client has not listened is chosen (401). In an embodiment, the channel may be a channel that is not explored for operation by the client and so on. The client then makes a check (402) if there is any beacon message on the respective channel. The beacon message gives an indication of the frequencies and bandwidth of operation of the spectrum. In case the beacon message is not received the step moves to 401. On the other hand, if the beacon message is received information regarding the RSSI on the beacon channels and information regarding the ambient interference channels is conveyed (403) to the AP 101. Further, a suitable radio and band for transmission is chosen (404) on the AP 101 and an association request is sent to get associated with the AP 101. A check is then made (405) if there is any management frame. If there is no management frame, the step moves to 405. If there is management frame received then the channel is switched (406) to the allotted band or radio. The various actions in method 400 may be performed in the order presented, in a different order or simultaneously. Further, in some embodiments, some actions listed in FIG. 4 may be omitted.

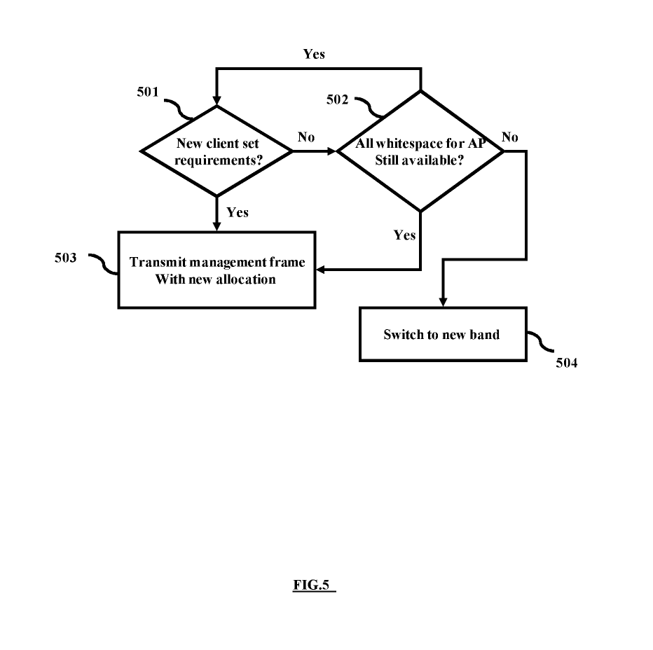

FIG. 5 is a flow diagram depicting the process of transmitting management time frames for the access point, according to an embodiment as disclosed herein. The management frames are required to handle disruptions due to sudden change in the spectrum available and also handle client churn. When a new client arrives or departs a check is made if the client's set of requirements are satisfied. If the requirements are satisfied then management frame is transmitted (503) with the new allocation details. In case the requirements are not satisfied then a check is made (502) if all the whitespaces available for the AP 101 are still available. In an embodiment, new set of whitespaces are chosen only if it substantially improves the utility upon the system performance significantly. This minimizes the switching overhead. Further, the AP 101 detects if the band it is operating on is still available and performs whitespace selection and client assignment. The AP 101 further sends this information over the management frame. On the other hand, if the client experiences a certain band becoming unavailable, but the AP 101 does not, then the client switches (405) to another band on which the AP is operating. Note that handling disruptions in multi radio case is simplified as compared to the single radio case. Further, when the whitespaces are available the process moves to step 503. The management frames are meant to convey the changes in allocation over each radio and over the entire bandwidth. Further, note that the management frames have to be sent only in order of seconds where there is significant churns or disruptions. The various actions in method 500 may be performed in the order presented, in a different order or simultaneously. Further, in some embodiments, some actions listed in FIG. 5 may be omitted.

In an embodiment, after the transition to all digital TV transmissions, the available TV bands are 54-72 MHz (channels 2; 4), 76-88 MHz (channels 5; 6), 174-216 MHz (channels 7; 13) and 470-698 MHz (channels 14; 51). These bands can be used for unlicensed access of fixed and portable devices.

In an embodiment, fixed devices can operate from channel 2-51 and transmit at a maximum of 4 W. This is relevant to the IEEE 802.22 standard. The 802.22 standard's goal is similar to that of WiMAX (i.e., 802.16), in that it aims to provide wide area wireless broadband connectivity. It is based on an infrastructure of base stations, with clients communicating directly with the base stations.

In an embodiment, portable devices are intended to provide short range communications similar to Wi-Fi, and they can operate in two modes: either as a client (Mode I) or independently (Mode II). In Mode I, the portable device is in a master slave relationship either with a fixed device or a Mode II portable device. On the other hand, portable devices can operate only in channels 21-51.

Further note that the available spectrum is distributed anywhere from 54 MHz up to 698 MHz. Clearly, in order for clients to associate either in IEEE 802.22 or for an enterprise WLAN in the DTV whitespaces they need to know over which bands their respective BS/APs are operating on. Consider an embodiment for the case of an enterprise WLAN scenario where access points are located across an enterprise and client devices can connect and communicate with the access points over the DTV whitespaces. Note that since we are considering portable devices, the frequency bands of operation are distributed from 470-698 MHz.

In an embodiment, there are several advantages of reserving a small bandwidth or time slices and they are as follows. 1. Robustness: This approach makes the control channel robust to client's experience of the channels. For example, if a client is experiencing high interference in some pieces of the spectrum where the AP is operating in, it can still access the control channel if the AP is operating over a larger bandwidth or if the AP has multiple radios (each radio operates over distinct frequencies). Also, it is possible that the maximum bandwidth that a client radio can operate over is limited (more expensive a radio, it can simultaneously operate over larger bandwidth). In such a scenario, by dedicating radio resources over every B MHz channel that an AP operates over, the control channel can be made to work for arbitrary client-side radios.

2. Low access delay: For AP's with multiple radios, the delay incurred in client connecting to the AP can be reduced since part of the control mechanism exists for every B MHz of channel.

3. Scalability: The mechanism scales well with multiple AP's (possibly owned by different entities) in close proximity. As long as near-by AP's operating spectrum do not completely overlap (which is likely to happen with a good MAC design and when there is enough whitespace available), the proposed approach is much more scalable compared to an approach where some fixed band is used for control mechanism.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to he understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. An access point for dynamic allocation of bandwidths in television whitespace spectrum for plurality of clients, said access point configured for
performing a scan at intervals to determine available channels in said television whitespace spectrum;
periodically sending messages over at least one said available channel of said television whitespace spectrum;
accepting a request message from a client from said plurality of clients; and
allocating at least one of the radios of said access point to said client for communication over said television whitespace spectrum.

2. The access point as in claim 1, wherein said access point sends said periodic messages where said message is a beacon message indicating center frequencies of operation, operating bandwidth at each of said center frequencies, signal strengths.

3. The access point as in claim 1, wherein said access point further sends said message to said client on event basis.

4. The access point as in claim 1, wherein said access point sends said messages periodically, where said period is pre-defined by said network operator and depends on factors that include at least one of
channel switching overhead;
duration of beacon message; and
tolerable overhead.

5. The access point as in claim 1, wherein said access point accepts said request where said request is a request for association of said client in order to service said client.

6. The access point as in claim 1, wherein said access point further allocates time slices at intervals over bandwidth of said spectrum for control channel.

7. An access point for handling disruptions in dynamic allocation of bandwidths in television whitespace spectrum, said access point configured for
detecting if said bandwidth of said television whitespace spectrum on which said access point is operating is available;
performing whitespace selection and client assignment if said bandwidth on said television whitespace spectrum is not available; and
sending a message over a management frame to a client associated with said access point.

8. The access point as in claim 7, where said access point sends said message where said message gives information on changes in allocation of said bandwidth for said client.

9. A method for dynamic allocation of bandwidths in television whitespace spectrum for plurality of clients, said method comprising
performing a scan at intervals to determine available channels in said television whitespace spectrum;
periodically sending messages over at least one said available channel of said television whitespace spectrum;
accepting a request message from a client from said plurality of clients; and
allocating at least one of the radios of said access point to said client for communication over said television whitespace spectrum.

10. The method as in claim 9, wherein method sends said periodic messages where said message is a beacon message indicating center frequencies of operation, operating bandwidth at each said of center frequencies, signal strengths.

11. The method as in claim 9, wherein said method further sends said message to said client on event basis.

12. The method as in claim 9, wherein said method sends said messages periodically, where said period is pre-defined by said network operator and depends on factors that include at least one of
channel switching overhead;
duration of beacon message; and
tolerable overhead.

13. The method as in claim 9, wherein said method accepts said request where said request is a request for association of said client in order to service said client.

14. The method as in claim 9, wherein said method further allocates time slices at intervals over bandwidth of said spectrum for control channel.

15. A method for handling disruptions in allocation of bandwidths in television whitespace spectrum, said method comprising
detecting if said bandwidth on said television whitespace spectrum on which an access point is operating is available;
performing whitespace selection and client assignment if said bandwidth on said television whitespace spectrum is not available; and
sending a message over a management frame to a client associated with said access point.

16. The method as in claim 15, where said method sends said message where said message gives information on changes in allocation of said bandwidth for said client.

17. A method for handling disruptions in allocation of bandwidths in television whitespace spectrum, said method comprising
checking by a client if a bandwidth on which said access point is operating on said television whitespace spectrum is unavailable;
checking if said access point is still available for service in said television whitespace spectrum;
if said access point is available for service in said television whitespace spectrum switching said client to a new bandwidth on which said access point is operating.

18. The method as in claim 17, wherein said method switches said client to said new bandwidth by performing reallocation of bandwidth for said client.
